(19) United States
(12) Patent Application Publication
(10) Pub. No.: US 2020/0044212 A1
(43) Pub. Date: Feb. 6, 2020

(54) SCALABLE BATTERY SYSTEM

(71) Applicant: TTI (MACAO COMMERCIAL OFFSHORE) LIMITED, Macau (CN)

(72) Inventor: Hei Man Raymond LEE, Kwai Chung (CN)

(21) Appl. No.: 16/339,278

(22) PCT Filed: Mar. 31, 2017
(86) PCT No.: PCT/CN2017/078971

§ 371 Date: Apr. 3, 2019

(51) Int. Cl. H01M 2/10; H01M 2/20

(52) U.S. Cl. CPC H01M 2/1077; H01M 2220/20; H01M 2/206

(57) ABSTRACT

A battery module contains a casing, a cell frame received within and connected to the casing, a first connector mounted to the cell frame; a second connector mounted to the cell frame; and a plurality of sub-modules installed in the cell frame. Each of the plurality of sub-modules includes a plurality of battery cells. Each of the plurality of sub-modules further contains a positive output terminal and a negative output terminal that are connected to the first connector or the second connector. A plurality of interconnecting features allows the battery module to detachably connect to an adjacent battery module of a same type to form a scalable battery system. Similar battery modules can be stacked to form a battery system with additional capacity, without the need to modify the internal structure or circuit connection of the individual battery module.

### FIELD OF INVENTION

This invention relates to an energy storage device; and in particular to battery modules used for electric vehicles.

### BACKGROUND OF INVENTION

Electric or hybrid powered vehicles as important types of new energy vehicles are used more and more frequently in road transportations during the last decade, due to their low or zero emissions as well as the more desired torque characteristics of electric motors over internal combust engines. For an electrically driven vehicle, irrespective of whether the electric motor is the only mechanical power source or not, the battery system is a core part of the vehicle which is carefully designed to provide as larger capacity as possible, while providing the required output voltage within the limitation imposed on the size due to the limited space on the vehicle.

A common design difficulty encountered by electric vehicle engineers is that quite often, a sophisticated battery system designed with plenty of efforts is only suitable for a specific model of vehicle. This is because the internal connection between battery cells in the battery system needs to be specifically configured to obtain the required output voltage for the need of the vehicle and is thus only applicable to this vehicle only. Also, a battery management system is usually required in the battery system but again the battery management system needs to be designed with respect to a particular battery system. The conventional battery system therefore lacks a degree of flexibility and is unable to be adapted to different vehicles which may have different space limitations and/or required electric power characteristics.

### SUMMARY OF INVENTION

In the light of the foregoing background, it is an object of the present invention to provide an alternate battery system which eliminates or at least alleviates the above technical problems.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

Accordingly, the present invention, in one aspect, is a battery module contains a casing, a cell frame received within and connected to the casing, a first connector mounted to the cell frame; a second connector mounted to the cell frame; and a plurality of sub-modules installed in the cell frame. Each of the plurality of sub-modules includes a plurality of battery cells. Each of the plurality of sub-modules further contains a positive output terminal and a negative output terminal that are connected to the first connector or the second connector. A plurality of interconnecting features allows the battery module to detachably connect to an adjacent battery module of a same type to form a scalable battery system.

Preferably, in each of the plurality of sub-modules the battery cells are connected in series; the plurality of sub-modules having their negative outputs connected to the first connector, and their positive outputs connected to the second connector, whereby the plurality of sub-modules are connected in parallel.

More preferably, the casing defines an opening having a substantially rectangular shape for receiving the cell frame. A depth of the casing substantially is defined by a length of one battery cell.

In an exemplary embodiment of the present invention, the plurality of interconnecting features include screws on the casing which extend at least over the depth of the casing to mechanically the battery module to the advancement battery module of a same type.

According to another exemplary embodiment, the first connector and the second connector are conductive bars extending at least over the depth of the casing, such that that when the battery module is connected to the adjacent battery module the first connector and the second connectors electrically connect to their respective counterparts on the adjacent battery module.

In another implementation, the first connector and the second connector are configured on a same side of the cell frame defining an interface plane. The battery module further includes an intermediate connector connected to one or more of the battery cells.

In another implementation, the intermediate connector is located between the first and second connectors in the interface plane.

In another implementation, the battery cells in one said sub-module are aligned substantially along a direction parallel to the interface plane. All the positive outputs of the sub-modules, and all the negative outputs of the sub-modules aligned respectively along a direction vertical to the interface plane.

In another implementation, all the positive outputs of the sub-modules are connected to a positive power bar which is in turn connected to the second connector and extending along the direction vertical to the interface plane. All the negative outputs of the sub-modules are connected to a negative power bar which is in turn connected to the first connector and extending along the direction vertical to the interface plane.

In a variation of the above battery module, the cell frame contains a reinforcing structure which is away from the perimeter of the cell frame.

In another variation of the above battery module, the battery cells as installed in the cell frame are spaced apart from each other at a distance of 2 mm or 3 mm.

In another variation of the above battery module, the casing contains a round corner.

In another variation of the above battery module, the cell frame is detachably connected to the casing.

According to another aspect of the present invention, a scalable battery system contain more than one battery modules, the more than one battery modules interconnected to form a stack; and a battery management system installed to one side of the stack.

According to a further aspect of the present invention, there is provided an electrically driven machine includes a scalable battery system.

Preferably, the machine is a vehicle.

More preferably, the machine contains a first scalable battery system and a second scalable battery each includes a battery management system. The two battery management systems are adapted to be configured as a master and a slave.

There are many advantages to the present invention, for instance the battery system is a fully scalable one enabling different numbers of battery module to be combined. Such scalability requires no modification to the structure of a single battery module or its internal circuit. Rather, the battery modules can be easily stacked up to increase the total capacity manifold. A common use for such scalability is to increase the overall capacity of the battery system when space allows, while having no effect on the output voltage/current of the battery system. This is for example useful for vehicles equipped with the same or similar electric motor, but having different vehicle bodies for installing battery systems of various sizes. In other applications, the desired voltage outputted by the entire battery system can be easily altered by connecting individual battery modules in different ways, such as series/parallel connections.

Another advantage of the present invention is that when more than one battery modules are interconnected, there is no need for a dedicated battery management system for the combined battery modules. Rather, the individual battery management systems contained in the battery models can be easily configured in a master-slave mode, preferably in an automatic way, so that any one of the battery management systems can be used as a connecting interface for the battery system to connect to external controllers.

### BRIEF DESCRIPTION OF FIGURES

The foregoing and further features of the present invention will be apparent from the following description of preferred embodiments which are provided by way of example only in connection with the accompanying figures, of which:

FIG. 1 is an illustration of a scalable battery system according to a first embodiment of the present invention.

FIGS. 2a and 2b show respectively the top view and side view of a battery compartment on an electric vehicle which contains a battery system, according to a second embodiment of the present invention.

FIGS. 2c and 2d show respectively the top view and side view of a battery compartment on an electric vehicle which contains a battery system, according to a further embodiment of the present invention.

FIGS. 2e and 2f show respectively the top view and side view of a battery compartment on an electric vehicle which contains a battery system, according to a further embodiment of the present invention.

FIGS. 2g and 2h show respectively the top view and side view of a battery compartment on an electric vehicle which contains a battery system, according to a further embodiment of the present invention.

FIG. 3 is the front view of a battery module according to an embodiment of the present invention, with the battery cells in the battery module omitted.

FIG. 4a is the perspective view of a battery module according to another embodiment of the present invention, with the battery cells omitted.

FIG. 4b is the front view of the battery module in FIG. 4a but with the casing removed.

FIG. 5 shows multiple battery modules of FIGS. 4a and 4b stacked up in a perspective view.

FIG. 6 is a partial view of stacked battery modules with the casing removed to show various connectors for the battery modules, according to a further embodiment of the present invention.

FIG. 7 shows the front view of a battery module according to another embodiment of the present invention, with a side of the casing removed.

FIG. 8 shows the alignment and distance between various battery cells in the battery module in FIG. 7,

FIG. 9 is the schematic diagram of the battery system consisted of two battery modules connected in series according to a further embodiment of the present invention.

FIG. 10 is the schematic diagram of the battery system consisted of three battery modules connected in parallel according to a further embodiment of the present invention.

FIG. 11 is the functional diagram of internal components of a battery system according to a further embodiment of the present invention.

FIG. 12 is the schematic diagram of an electric vehicle according to a further embodiment of the present invention.

In the drawings, like numerals indicate like parts throughout the several embodiments described herein.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to electrical coupling or connection either directly or indirectly via one or more electrical means unless otherwise stated.

Terms such as “horizontal”, “vertical”, “upwards”, “downwards”, “above”, “below” and similar terms as used herein are for the purpose of describing the invention in its normal in-use orientation and are not intended to limit the invention to any particular orientation.

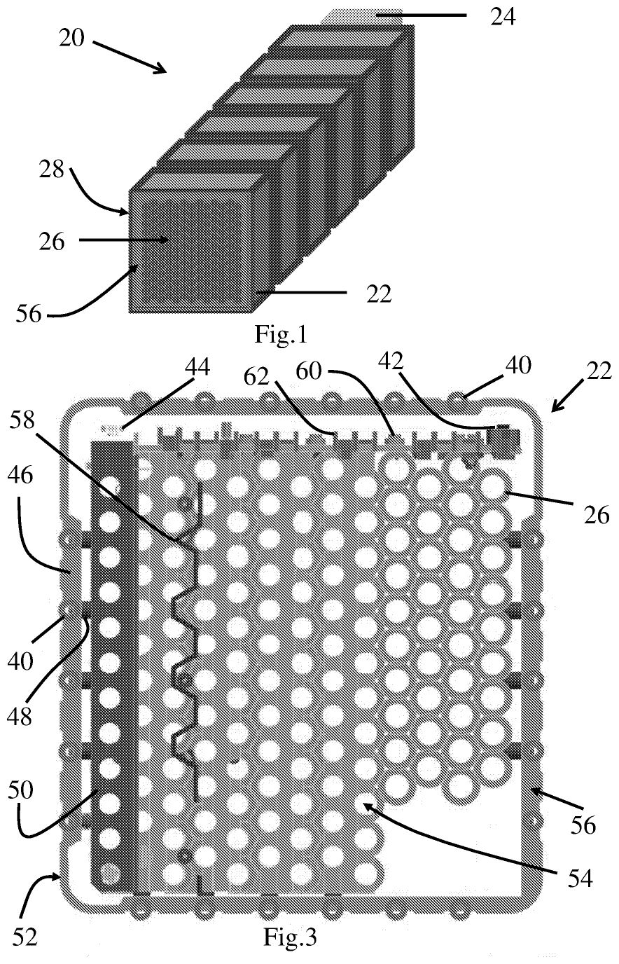

Referring now to FIG. 1, the first embodiment of the present invention is a scalable battery system 20 consisted of multiple battery modules 22 connected to each other in a stacked manner. As shown in this example there are in total six battery modules 22 electrically connected in parallel (as will be described in more details later). Each of the battery modules 22 contains a cell frame 26 in which a predetermined number of battery cells (not shown) are accommodated and electrically connected. The cell frame 26 is received in and detachably secured to a casing 56. At the front end of the stack, there is a waterproof seal 28 (shown as transparent part in this figure) covering the cell frame 26 which would otherwise be exposed to the external environment. At the rear end of the stack, there is a battery management system (BMS) 24 installed to the closest battery module 22. The structure and functions of battery management systems will be described separately in more details later.

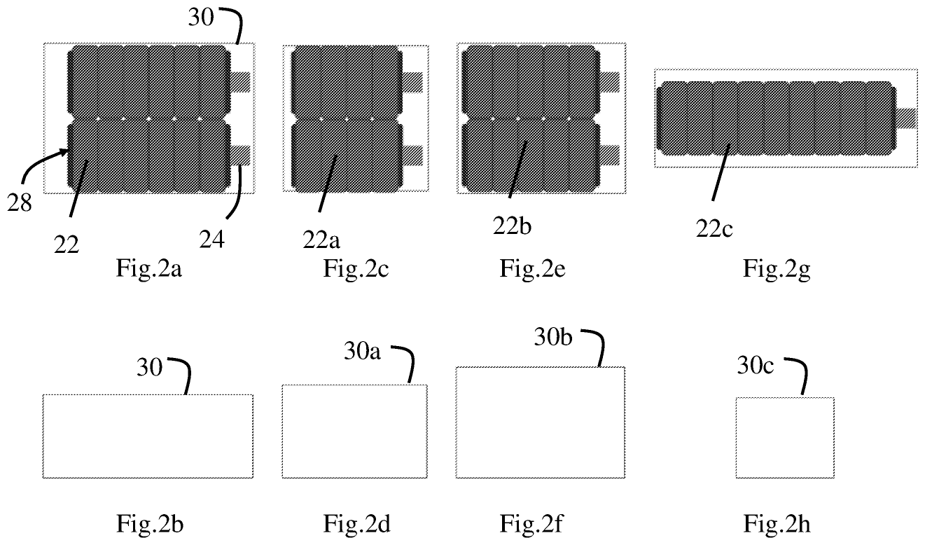

FIGS. 2a and 2b show two battery systems 20 each with a configuration described above that are installed in a battery chamber 30 of an electric vehicle. Note that the two battery systems 20 are placed side by side and it can be seen that the two battery systems 20 occupy most of the space in the battery chamber 30. Each battery system 20 contains six battery modules 22, a BMS 24 and a waterproof seal 28. As a result, there are two BMS 24 in total. FIG. 2b shows the height of the battery chamber 30 with the battery systems 20 hidden. In FIGS. 2c and 2d, a different configuration of battery systems is shown where there are only four battery modules 22a in each battery system. The height of the battery chamber 30a is also larger than that of FIG. 2b. In FIGS. 2e and 2f, a different configuration of battery systems is shown where there are five battery modules 22b in each battery system. The height of the battery chamber 30a is even larger than that of FIG. 2d. In FIGS. 2g and 2f, a different configuration of battery system is shown as there is only a single battery system which contains nine battery modules 22c. The height of the battery chamber 30c is smaller than that of FIG. 2d. Note that in FIGS. 2c-2h the battery modules are configured with a maximum possible number within the given space of the battery chamber on particular electric vehicles. In this way the battery system equipped on each type of vehicle has a capacity as large as possible, as a result of the number of battery modules in each battery system being flexibly adjusted without affecting the output current/voltage of the whole battery system. This will be described in more details below.

Turning now to FIG. 3, the battery module 22 as illustrated in FIG. 1 is shown with a focus on its internal structure. The casing 56 has a closed shape defining two openings separated by a depth of the casing 56. Each of the openings has a rectangular shape and FIG. 3 shows one such opening from which the cell frame 26 in the casing 56 can be seen. The four corners of the rectangular shape are formed as round corners 52 which help reduce the overall size of the casing 56. The cell frame 26 has a shape similar to that of the casing 56 for it to be received in and occupy most space in the casing 56. However, the cell frame 26 is spaced away from the interior sides of the casing 56 at a certain distance to allow rooms for wire connections. The cell frame 26 is formed with many identical perforations 54, each of which is adapted to receive a single battery cell (not shown), such as 18650 type battery cells. The battery cell therefore is inserted into the perforation 54 along a direction perpendicular to the plane of the page, which is the depth direction of the casing 56. The depth of the casing 56 is determined by the length of a single battery cell inserted into the cell frame 26. Within the cell frame 26 there is configured a reinforcing structure 58 which has a meander shape and placed between adjacent perforations 54 to increase the strength of the cell frame 26. The reinforcing structure 58 is located within the cell frame 26 and away from the perimeter of the cell frame 26.

The cell frame 26 is detachably fixed to the interior perimeter of the casing 56 by a number of screws 48. As shown in FIG. 3 such screws 48 are present on two opposing sides of the cell frame 26. The screws 48 have their longitudinal directions perpendicular to the above mentioned depth direction of the casing 56 and can be actuated by the user from outside of the casing 56. On the other hand, there are further screws 40 formed on the casing 56 but these screws 40 have their longitudinal directions parallel to the depth direction mentioned above. The screws 40 extend at least over the depth of the casing 56 so that a screw 40 on one battery module 22 can readily connect to its counterpart screw 40 on another battery module to make the two battery modules 22 interconnected in a stacked manner. To enable such connection each screw 40 has a male end and a female end (not shown) so that two identical screws 40 can detachably connect to each other by screwing the male end into the female end. As a result, one battery module 22 can be detachably connected to another battery module 22 in a side-by-side manner at either one of the two sides. As shown in FIG. 3 screws 40 are present on all four sides of the casing 56 although the number of screws 40 on each side varies from five to six. The portions of casing 56 where screws 40/screws 48 are present are thickened to form a reinforced structure so as to provide better strength for the connection of screws 40/screws 48.

The battery module 22 shown in FIG. 3 is a 13S12P type, i.e. there are twelve sub-modules connected in parallel, with each of the sub-module contains thirteen individual battery cells connected in series. However, please note that for the sake of brevity a small portion of perforations 54 at the lower right corner of the cell frame 56 is hidden in FIG. 3. This means that if the battery cells have a rated output of 3.6V and a capacity of 3.0 Ah, then the total voltage outputted by the battery module 22 is 3.6V*13=46.8V and the total capacity of the battery module 22 is 3.0 Ah*3.6V*13*12=1684.8 Wh. Each battery sub-module is defined by a group of battery cells as indicated by their respective perforations 54 which are substantially aligned in a direction perpendicular to the longitudinal direction of a negative power bar 50. In the meantime, the twelve sub-modules are aligned along a direction parallel to the longitudinal direction of the negative power bar 50. In this way, the negative power bar 50 which is made of a good conductive material such as copper is coupled to the negative output of every battery sub-module in the battery module 22 where all these negative outputs are located adjacent to a same side of the casing 56.

At one end of the negative power bar 50 there is connected a negative connector 44 extending from the cell frame 26. Similarly, on the same side of the cell frame 26 but at an opposite end to that of the negative connector 44 there is a positive connector 42. The positive connector 42 is connected to a positive power bar (not shown) where the positive power bar connects to all the positive outputs of sub-modules in the battery module 22. The positive connector 42 and the negative connector 44 are made of good conductive materials such as copper with a sufficient dimension to allow passing through of large current outputted by the entire battery module 22. The positive connector 42 and the negative connector 44 define an interface plane parallel to the side of the cell frame 56 from which the positive connector 42 and the negative connector 44. The interface plane also contains other connectors, such as intermediate connectors 60. There are four intermediate connectors 60 in the interface plane as shown in FIG. 3, and each intermediate connector is bounded by two walls 62. The intermediate connectors 60 are used to perform voltage sampling of intermediate battery cell(s) in any battery sub-module and also to perform cell balancing to the battery cell(s) within in the battery sub-module.

More than one battery module 22 as described above can be easily stacked up to constitute a battery system, although for the battery system to be functional a battery management system is also required. Due to the interconnecting functions provided by screws 40 as described above, two or more battery modules 22 can be mechanically connected. Such connections between two or more battery modules 22 are reversible, so that when needed the battery modules 22 can be separated from each other. In addition, for the two or more battery modules 22 to electrically connect to each other, the positive connector 42 and the negative connector 44 on each battery module 22 would contact physically with their counterparts on an adjacent battery module 22 once the two battery modules 22 are fastened by screws 40, since the positive connector 42 and the negative connector 44 each has a length at least equal to the depth of the casing 56. The same applies to any intermediate connector 60. In this way, all battery modules 22 in a stack will have their respective connectors lined up and forming continuous conductive bars, and the battery modules 22 are electrically connected in parallel in this configuration. The screws 40, the positive connector 42, the negative connector 44 and the intermediate connector 60 are all interconnecting elements that facilitate combination of two or more battery modules 22 to form a stack.

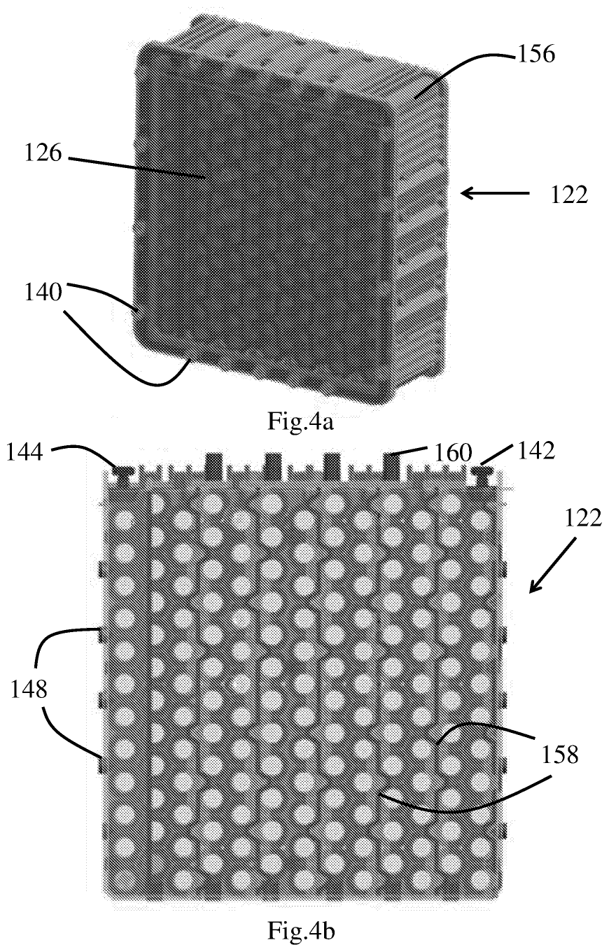

FIGS. 4a-4b show another embodiment of the invention where a battery module 122 has a general shape similar to that as shown in FIGS. 1-3. For the sake of brevity only the difference of this battery module 122 as compared to the battery module shown in FIGS. 1-3 will be described herein. In FIG. 4b, one can see that the number of screws 140 used for interconnecting two or more identical battery modules 122 which are located on the casing 156 are different from that in FIGS. 1-3. Screws 140 are present on all four sides of the casing 156 although the number of screws 140 on each side varies from four to five. The number of screws 148 used to connect the cell frame 126 to the casing 156 is also less than that in FIGS. 1-3. FIG. 4b also shows four intermediate connectors 160 located between the positive connector 142 and the negative connector 144. Lastly, there are multiple reinforcing structure 158 located in the cell frame 126 which are substantially parallel to each other.

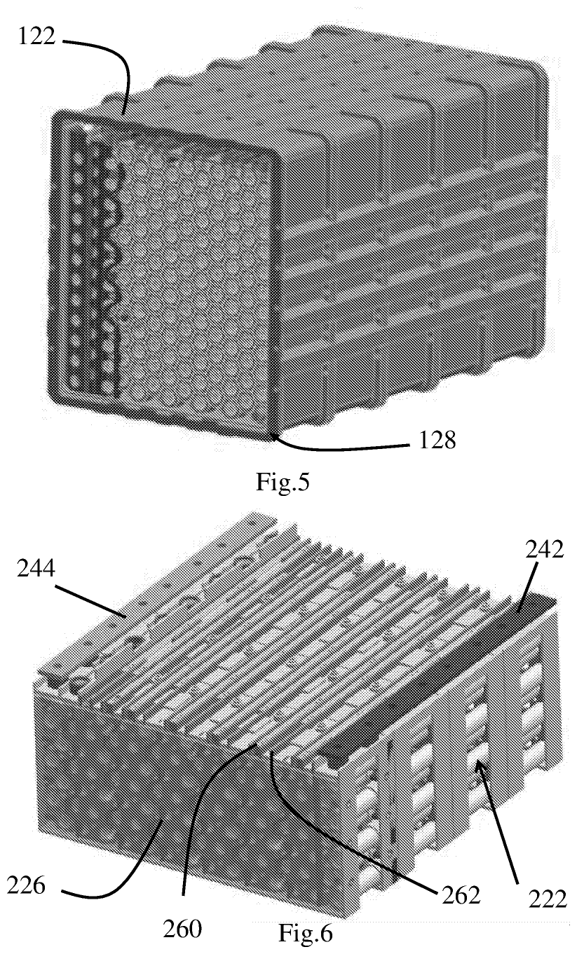

FIG. 5 shows five battery modules 122 interconnected with each other to form a stack. All the battery modules 122 are identical and once they are stacked up the overall shape of the stack is a cubic shape. On the front end of the stack there is installed a waterproof seal 128 to prevent external liquid from entering the interiors of the battery modules 122.

FIG. 6 shows another embodiment of the present invention which is a stack of four battery modules 222. However, only an upper part of the battery modules 222 are shown, and what is more clearly shown in FIG. 6 is the various connecting bars on top of the cell frames 226 as the casing is removed for better illustration. The positive connectors 242 of all the battery modules 222 are aligned along a straight line and are firmly contacting each other to enable a good electric connection, as a result of the battery modules 222 interconnected with each other. Note that the positive connectors 242 themselves are formed as bar shape but these positive connectors 242 are connected respectively to their cell frames 226 by stubs 243. The cross-sectional shape of a positive connector 242 and its stub(s) 243 is a “T” shape similar to that shown in FIG. 4b. The structure of the negative connectors 244 and their respective stubs 243 are similar to the case of the positive connector 242. The positive connectors 242 and the negative connectors 244 are located on two opposite ends of the top face of the battery module 222. There are also multiple intermediate connectors 260 placed on the top face of which the functions are similar to those mentioned above. The intermediate connectors 260 are each bounded by two walls 262 extending upwardly from the top face. The negative connectors 244, the negative connectors 244 and the intermediate connectors 260 are all positioned in the same interface plane.

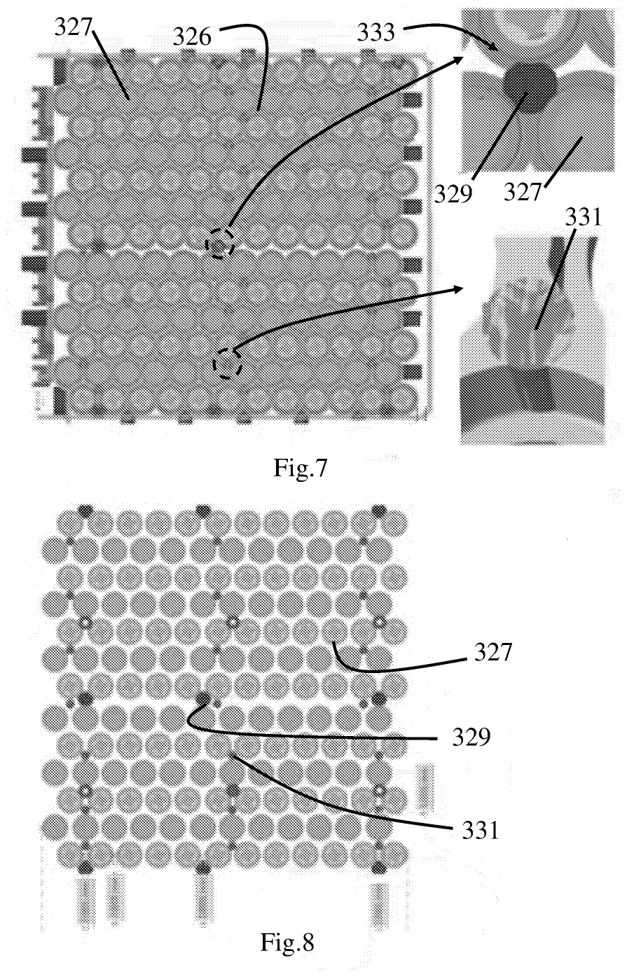

FIG. 7 shows another embodiment of the present invention which is a cell frame 326 used in a battery module. The cell frame 326 is used to accommodate and secure multiple battery cells 327 where the portion of the cell frame 326 around each battery cell 327 is formed as a round shape cell holder 333. One can see that in FIG. 7 there are different gap sizes between adjacent cell holders 333 at different locations in the cell frame 326. For example, at some locations the gap size is larger to accommodate a larger screw boss 329 in the gap for tightening the cell frame 326. The gap size is 3.0 mm for the larger screw boss 329. At some other locations, the gap size is smaller, say 2.0 mm, for accommodate a smaller screw boss 331 for bonding. FIG. 8 shows the cells 327 installed in the cell frame of FIG. 7 but with the cell frame itself hidden in the drawing.

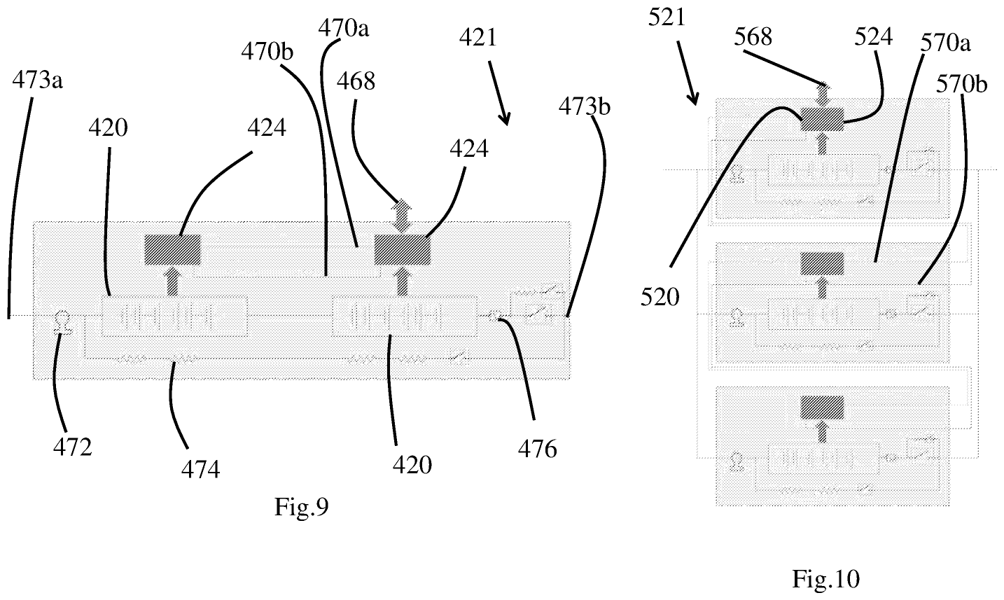

Multiple battery systems according to the present invention can be easily coupled to form a complete battery solution. An example is provided in FIG. 9 which shows two battery systems 420 each of which includes its own BMS 424 being connected in series to form the battery pack 421 of an electric vehicle. The two BMS 424 are connected through an internal Controller Area Network (CAN) and one of them is configured as a slave, while the other one is configured as a master and responsible for communicating with external devices (not shown) via a vehicle CAN 468. The master-slave mode can be configured either manually or automatically once the two battery systems 420 are connected through the internal CAN. The internal CAN is consisted of an index line 470a and a CAN line 470b. The battery systems 420 are connected in series with a current shunt 472, a fuse 476 and a pre-charge switch group 475 between the battery circuit negative output 473a and battery circuit positive output 473b. The battery systems 420 are also connected in parallel with a number of heaters 474. The total voltage outputted by the battery circuit in FIG. 9 is twice as that outputted by a single battery system 420, and for 48V battery systems the total outputted voltage will be 96V.

FIG. 10 shows a further embodiment where three battery systems 520 are connected in parallel to form a battery pack 521. Again, each of the battery systems 520 contains a BMS 524 and one such BMS 524 is configured as master for communicating with external devices (not shown) via a vehicle CAN 568. The other two BMS 524 are configured as slaves and they communicate with the master via internal CAN 570a, b. The total voltage outputted by the battery circuit in FIG. 10 is the same as that outputted by a single battery system 520, and for 48V battery systems the total outputted voltage will still be 48V.

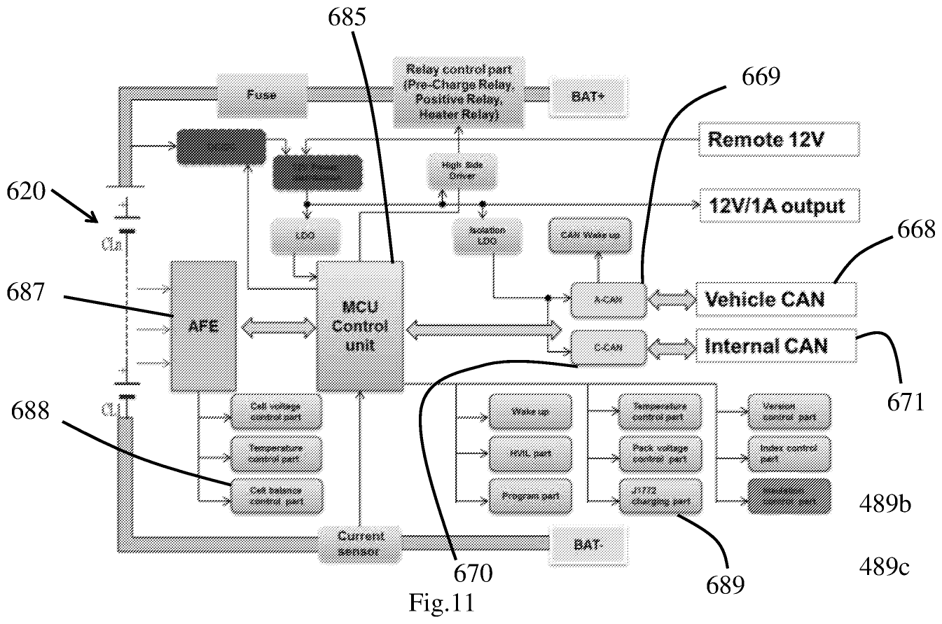

FIG. 11 shows an embodiment of the present invention which is a BMS that can be used with the battery modules described above for electric vehicles. As shown in FIG. 11, battery modules 620 connect to the BMS which contains the key components including an Analog Front End (AFE) 687 connected directly to the battery modules 620 and a MCU 685 connected to the AFE 687. The MCU 685 is adapted to communicate with other components in the vehicle through a vehicle CAN 668 by an A-CAN interface 669. The MCU 685 is also adapted to communicate with other similar BMS in other battery systems in the vehicle through an internal CAN 670 by a C-CAN interface 671. The AFE 687 is adapted to perform various functions as shown in blocks 688 including but not limited to cell voltage monitoring, sampling, filtering, and cell voltage balancing. The AFE 685 is adapted to perform various functions as shown in blocks 689.

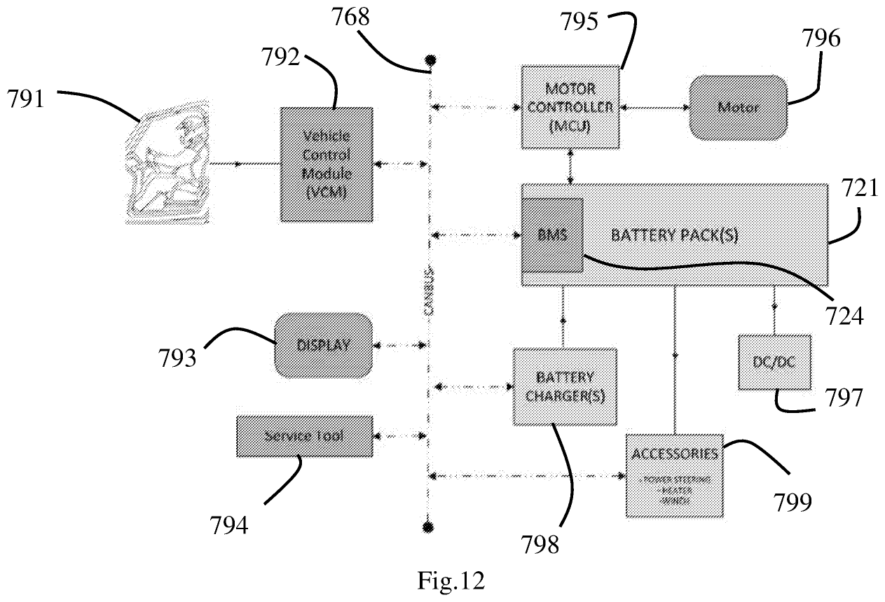

Turning now to FIG. 12, a further embodiment of the present invention shows a complete functional block diagram of the electrical components in an electric vehicle. The battery pack 721 contains a BMS 724 which is configured to communicate with a Vehicle Control Module (VCM) 792 through a vehicle CAN 768. The VCM 792 receives inputted command from the vehicle driver 791 and may also provide feedbacks and status to the driver 791. The VCM 792 also controls other parts of the vehicle like a display 793, battery charger 798, accessories 799, and the motor controller 795 through the vehicle CAN 768. A service tool 794 is allowed to perform maintenance to the electric vehicle through the vehicle CAN 768. The motor controller 795 upon receiving commands from the VCM 792 controls the electric motor 796 to operate in order to drive the electric vehicle, and the VCM 792 receives electric power supply from the battery pack 721 in order to drive the electric motor 796. The battery charger 798 is used to charge the battery pack 721 on the vehicle. The battery pack 721 is further connected to a DC/DC module 797 to provide DC voltage for other purposes, such as a 12V cigarette lighter.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It is to be understood that, if any prior art publication is referred to herein, such reference does not constitute an admission that the publication forms a part of the common general knowledge in the art, in Australia or any other country.

The embodiments described above show battery modules of 13s12p type in which the battery cells are connected series first to form sub-modules, and then these sub-modules are connected in parallel to form the whole battery module. However, skilled persons in the art should understand that other types of connections between the battery cells/sub-modules are also possible to obtain different output voltage/current of the battery module. For example, the battery cells may also be connected in parallel first to form battery sub-modules, and then these sub-modules be connected in series.

In addition, the 13s12p battery modules are just described and illustrated for the purpose of describing examples of the embodiment but other number of battery cells can also be configured in the battery module such as 13s11p and 13s10p. Also, the battery module described above is suitable for use with 18650 type battery cells, but one skilled in the art would realize that battery cells with other sizes like 20650 and 21700 may be used with cell frames with corresponding sizes which would still fall within the scope of the present invention.

The position of the interface plane in which the various connectors are present is on the top side of the cell frame as shown in the embodiments. However, it is also possible to have the interface plane located on the sides of the cell frame, or at the bottom face of the cell frame, as will be understood by skilled persons.

1. A battery module, comprising:
a casing;
a cell frame received within and connected to the casing;
a first connector mounted to the cell frame;
a second connector mounted to the cell frame; and
a plurality of sub-modules installed in the cell frame; each of the plurality of sub-modules including a plurality of battery cells; each of the plurality of sub-modules further including a positive output terminal and a negative output terminal that are connected to the first connector or the second connector;
wherein the casing includes a plurality of interconnecting features allowing the battery module to detachably connect to an adjacent battery module of a same type to form a scalable battery system.

2. The battery module according to claim 1, wherein in each of the plurality of sub-modules the battery cells are connected in series; the plurality of sub-modules having their negative outputs connected to the first connector, and their positive outputs connected to the second connector, whereby the plurality of sub-modules are connected in parallel.

3. The battery module according to claim 2, wherein the casing defines an opening having a substantially rectangular shape for receiving the cell frame; a depth of the casing substantially defined by a length of one said battery cell.

4. The battery module according to claim 3, wherein the plurality of interconnecting features include screws on the casing which extend at least over the depth of the casing to mechanically connect the battery module to the adjacent battery module of the same type.

5. The battery module according to claim 3, wherein the first connector and the second connector are conductive bars extending at least over the depth of the casing, such that that when the battery module is connected to the adjacent battery module the first connector and the second connector electrically connect to their respective counterparts on the adjacent battery module.

6. The battery module according to claim 5, wherein the first connector and the second connector are configured on a same side of the cell frame defining an interface plane; the battery module further includes an intermediate connector connected to one or more of the battery cells.

7. The battery module according to claim 6, wherein the intermediate connector is located between the first and second connectors in the interface plane.

8. The battery module according to claim 7, wherein the battery cells in one said sub-module are aligned substantially along a direction parallel to the interface plane; all the positive outputs of the sub-modules, and all the negative outputs of the sub-modules aligned respectively along a direction vertical to the interface plane.

9. The battery module according to claim 8, wherein all the positive outputs of the sub-modules are connected to a positive power bar which is in turn connected to the second connector and extending along the direction vertical to the interface plane; all the negative outputs of the sub-modules are connected to a negative power bar which is in turn connected to the first connector and extending along the direction vertical to the interface plane.

10. The battery module according to claim 1, wherein the cell frame includes a reinforcing structure which is away from a perimeter of the cell frame.

11. The battery module according to claim 1, wherein the battery cells as installed in the cell frame are spaced apart from each other at a distance of 2 mm or 3 mm.

12. The battery module according to claim 1, wherein the casing includes a round corner.

13. The battery module according to claim 1, wherein the cell frame is detachably connected to the casing.

14. A scalable battery system, comprising:
a plurality of battery modules according to claim 1; the plurality of battery modules interconnected to form a stack;
a battery management system installed to one side of the stack.

15. An electrically driven machine comprising the scalable battery system according to claim 14.

16. The electrically driven machine according to claim 15, wherein the machine is a vehicle.

17. The electrically driven machine according to claim 15, wherein the electrically driven machine includes a first scalable battery system and a second scalable battery system, the first scalable battery system including a first battery management system, the second scalable battery system including a second battery management system, the first battery management system and the second battery management system adapted to be configured as a master and a slave.
